(19) United States
(12) Patent Application Publication
(10) Pub. No.: US 2015/0154623 A1
(43) Pub. Date: Jun. 4, 2015

(54) Menu Level Advocate and Reward System

(71) Applicant: Halliburton Energy Services, Inc., Houston, TX (US)

(72) Inventor: Yan Chuan Jin, Surrey (CA)

(21) Appl. No.: 14/002,152

(22) PCT Filed: May 24, 2013
(86) PCT No.: PCT/US2013/042678

§ 371 Date: Aug. 29, 2013

Related U.S. Application Data
(60) Provisional application No. 61/652,230, filed on May 27, 2012.

(51) Int. Cl. G06Q 30/02; G06Q 50/00; G06Q 50/12

(52) U.S. Cl. CPC G06Q 30/0214; G06Q 30/0226; G06Q 50/12; G06Q 50/01; G06Q 30/0236

(57) ABSTRACT

An advocate and reward process is dedicated to mobile users. The process includes the following steps: a consumer posts an advocate on the Electronic Menu and Reward (EMR) Bank for an ordered product or service; the consumer earns certain value of reward points based on the influence level of the advocate. The customer can redeem the reward points in his account when the reward points reach a certain level. Meanwhile, the merchant pays the same value reward points and a transaction fee to the EMR Bank. A customer can be linked to the EMR Bank system from smartphone applications, such as the On Location Master Menu (OLMM).

The current application is a PCT entering national stage of case PCT/US13/42678 that claims priority to the U.S. patent application No. 61/652,230 filed on May 27, 2012.

### FIELD OF INVENTION

This invention relates to a process of promotion for products and services, and more particularly, it is a menu level advocate and reward process, which is based on social networking and dedicated to mobile users.

### BACKGROUND OF THE INVENTION

Social network services have become an important hot hub for many human activities, such as contacting friends, providing and receiving useful information, and promoting a product or service etc. With the widespread of social network services, more and more people would like to share ideas, interests and daily activities with their friends or the public on social network sites. Moreover, after smartphone has been widely used, people now can conveniently perform social networking on their own phones at wherever they would go. Therefore, there is a huge social media formed accompanying social networking, which means great power of influence and consequently big potential values of the “Ads” on social network. The Ads hereby indicate advocates instead of advertisements. In comparison to advertisements, advocates, such as the word of mouth (WoM), are associated with contents that are usually more personalized and more credible to its viewers or listeners. Accordingly, more and more merchants want to promote their services or products, as well as collect valuable comments and feedbacks, on social network sites. Thus an advocate and reward process or system based on social networking would be very attractive to many merchants.

Such an advocate and reward system could be a potential profitable business model. Those traditional media, such as newspaper, magazine and TV, make their profits mainly from the advertisements. The prices being charged for the advertisements depend on the media's influence level to the public. Similarly, an individual's social media is also a kind of media, and it does have certain influence in its respective circle. However, currently there is no an established way for an individual to gain profit by leveraging his social media influence. So, how could make an individual's social media become profitable? There are a few services or systems have been proposed for this purpose.

Up to date, there are a few such systems and services associated with social networking. For example, Checkinsave is a social commerce system that allows customers to “check in” via social networks and earn points by sharing and having their friends check in after them. However, Checkinsave only provides a merchant-level referral reward system and only tracks and rewards the “check-in” activities. Another advocate and reward process, Grubhub, does offer online menu. But it is not dedicated to mobile users. Moreover, the reward system Rewardstream does not have a specific process to track individuals' influence after they advocate at the menu item level following experiencing services from merchants. Accordingly, there is a need for a menu level advocate and reward system that can track each advocate's influence and provide individuals rewards in accordance with their measured influence. With such a system, the merchant can get a more accurate and clearer idea about how well their product or service promotions (advocates) are received. On the other hand, the advocate makers, who are also the consumers, will get rewards directly linked to the influence of their advocates. They therefore will be more likely to make an advocate for a product or service they enjoyed, and the quality (attractive contents, details, images, etc) of the advocates will tend to be decent. The Electronic Menu and Reward (EMR) Bank is such a system with the foregoing functionalities.

### SUMMARY OF THE INVENTION

The present invention provides a menu level advocate and reward process by implementing a social networking style EMR Bank system. The EMR Bank may interact with individuals and merchants to realize a menu level advocate and reward process, which can track and measure the influence of an advocate about a merchant's product or service, and distribute appropriate rewards accordingly. The advocate and reward process could be dedicated to mobile device users to make the process of the present invention more accessible and more convenient to mobile users. For example, working together with certain mobile applications, EMR Bank will allow a consumer to order food items from the enrolled restaurants and quantify the influences when he advocates through a social media for the dishes he has enjoyed. Reward points will next be paid to him upon the quantified influences of his advocates, and can be redeemed anytime when he orders through the EMR Bank again.

### BRIEF DESCRIPTION OF THE DRAWINGS

FIG. 1 is a diagram showing the process of an order being initiated from the EMR Bank system.

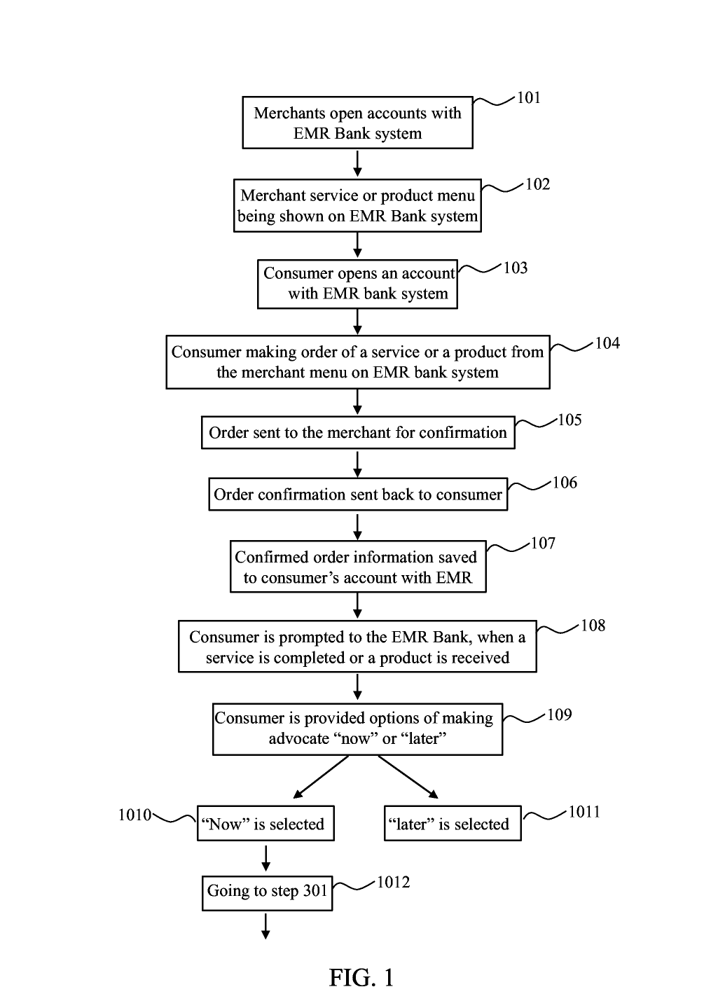

FIG. 2 is a diagram showing the process of an order being initiated from outside sources rather than the EMR Bank system.

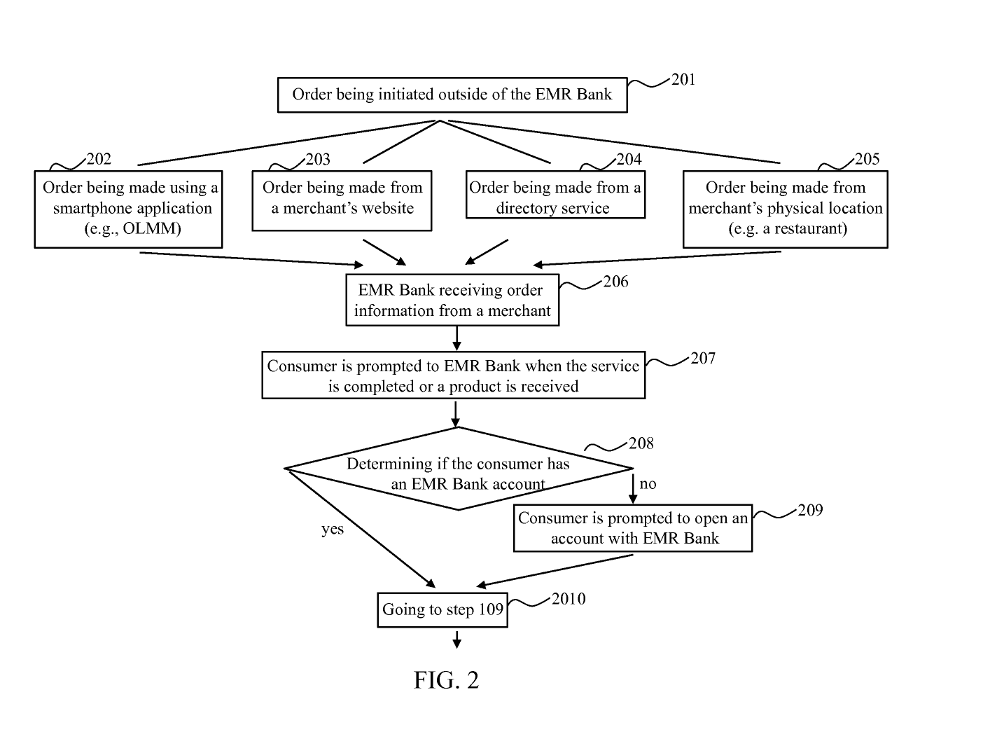

FIG. 3 is a diagram showing the process of making and storing an advocate made by a consumer.

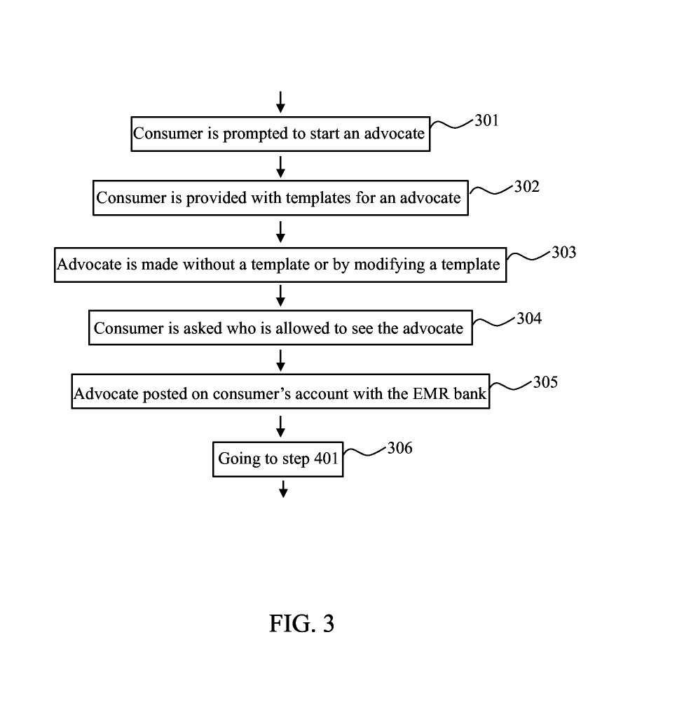

FIG. 4 is a diagram showing the process of tracking and measuring the influence of an advocate.

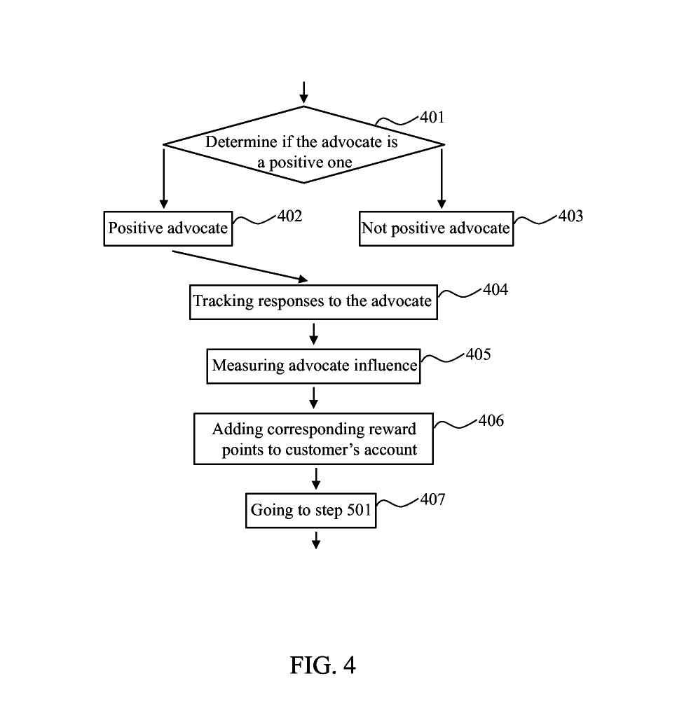

FIG. 5 is a diagram showing the process of redeeming reward points for a reward.

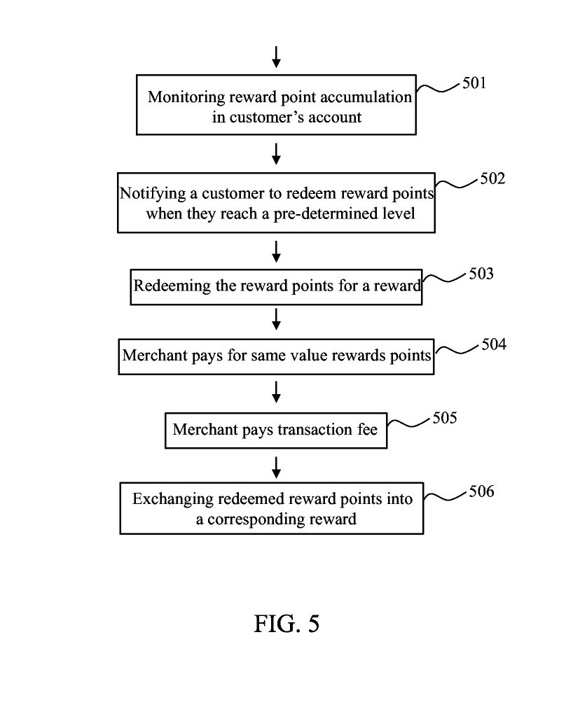

FIG. 6 is a diagram showing how an advocate's influence level is measured.

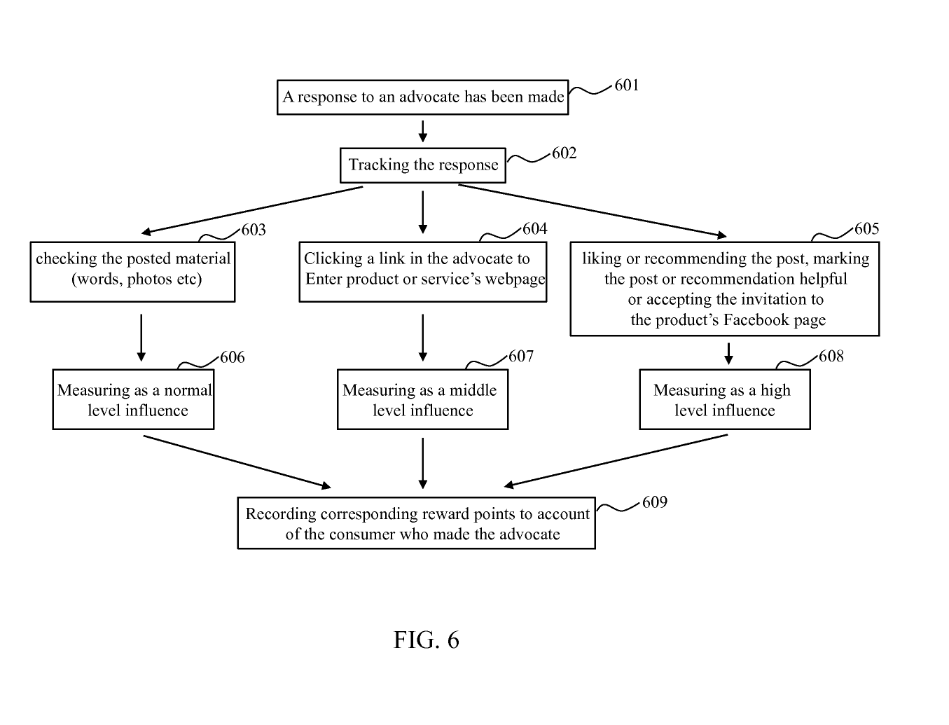

### DETAILED DESCRIPTION OF THE INVENTION

Hereinafter, the objective, conception and implementation of the present invention will be described in details with reference to the accompanying drawings and embodiments. In the detailed description, specific details are set forth in order to provide a thorough understanding of the present invention. However, it will be apparent to one of ordinary skill in the art that the present invention may be implemented without these specific details.

More and more people would like to post and read comments and advocates on the social media. These comments and advocates would significantly influence a consumer's decision about which service or product to purchase. Accordingly, due to their great power of influence, the advocates on social media are attracting the attentions from a great number of merchants. This is quite understandable, as some investigation shows that 28% of adults are likely to choose a restaurant they have not been before based on its information available on social media. Since many people tend to more believe the comments and recommendations from their friends, and would like to try what their friends like, the promotion via WoM could be an effective promotion method for many merchants. The WoM or advocate would be even more attractive to the merchants when the effect (influence) of such WoM (advocate) has been closely monitored and accurately measured by a system, which will offer the merchants a much more clear view about the public reception of their products or services, as well as a more efficient way to promote their products or services.

The EMR bank service is such a system to help merchants to promote their services or products, and help consumers to spread their comments and to be rewarded for their influential advocates and comments. Moreover, in comparison to that of conventional advertisements, the cost of the advocates with the EMR system is actually very low. Merchants only need to exchange “ads” with their products or services and pay the EMR Bank an agent (transaction) fee. Furthermore, the content of such advocate would be much more diversified, interesting and attractive to a potential purchaser, as for a single service or product, there could be hundreds of advocates directly from its recent consumers, with various commentary angles, various personal tones and colorful images. In addition, such advocates could be from friends or coworkers who a person tends to trust or would like to listen to. In this way, the EMR Bank is actually applied to let the word of mouth flow so as to provide an effective way for merchants to promote their products or services.

In the present invention, “ads” stands for “advocates”, and their application for restaurants can be described as an exemplary demonstration about how the EMR Bank works. For example, Albert enjoys the BBQ lamb at a restaurant, Shark Club. With enjoying the ordered meal, Albert may take a picture of the meal with his smartphone. Also with his smartphone, he could further check in the BBQ lamb page in the EMR

Bank system by simply scanning a QR (“quick response”) that may be located on the menu he's been provided at the restaurant. Then, Albert keys in “what's a wonderful meal”, clicks and posts his advocate to the EMR Bank. With Albert's consent, the EMR posts his advocate on his wall to be seen by all or selected friends. The EMR Bank tracks “who sees it”, evaluates the influence and distributes a reward based on its influence.

The advocate and reward process implemented by the EMR Bank will be more specifically described in reference to the accompanying drawings and embodiments. In order to use the EMR bank system, a merchant will first open a merchant account with the EMR Bank system 101. Upon opening an account, the merchant could further provide the information of its products and services, which will be shown as a menu on the EMR Bank 102. On the other hand, in order to get his advocate to be seen by his friends or the public and get rewarded by the EMR bank system, a consumer also needs to open a consumer account with the EMR Bank system 103.

Later on, when the consumer order a service or product from a merchant, he could do it either through the EMR bank system if such service or product is shown on the EMR Bank 104. Such order will be sent to the respective merchant for confirmation 105. The order confirmation information will be sent back by the system to the consumer 106. Also, the information of the confirmed order will be saved to consumer's account with the EMR Bank 107. In addition, the order can also be made from a merchant's website or physical location and then it will be linked to the EMR Bank. No matter which approach a consumer chooses, he can always do it through his smartphone.

The orders can also be made from outside of the EMR Bank system 201. For example, a consumer can make an order from a merchant's website 203; or from a directory service 204. The order can also be made from a merchant's physical location, such as a restaurant 205. And from there, they will be linked to the EMR Bank. As aforementioned, the EMR Bank, as a menu level advocate and reward system, could be dedicated to the mobile device users. The EMR Bank system has been specifically designed to facilitate a smooth interface and communication with such smartphone applications like On Location Master Menu (OLMM), to allow a consumer to make an order from the OLMM on his smartphone 202, and being linked from OLMM to the EMR Bank. No matter which outside ordering approach is used, the consumer's order information will be provided to the EMR Bank system 206 in order to track the consumer's advocate and it influence. When the ordered service is completed or the product is received, the consumer will be promoted to EMR Bank to make an advocate 207. It will be next determined if the consumer already has an account at the EMR Bank 208. In the case if a consumer does not have an EMR Bank account yet, the consumer will be promoted to open an EMR Bank account to make advocate and get the influence of his advocate tracked 209. When the consumer already has an EMR Bank account, he will be promoted to start making an advocate 301.

With enjoying the service or product he ordered, the consumer will be allowed to leave a comment (advocate) for his order at the EMR Bank, which could earn him certain rewards afterwards. The consumer will be promoted to EMR Bank's webpage when a service is completed or a product is received 108. When gets to the EMR Bank, the consumer will first be asked whether he would like to make an advocate “now” or “later” 109. If he chooses “later” 1011, he will not be promoted to make an advocate right now. If the consumer chooses “now” 1010, he will be promoted to start an advocate with the EMR Bank 301. In this case, the consumer will be provided with various related advocate templates 302. The consumer can customize it to fit for his own tones and experience. The customer may also choose to make his own advocate without using the provided template 303. When the advocate is finished, the customer will be asked who is going to be allowed to see the advocate, the public, all or only some of his friends, etc 304. Finally, the advocate will be posted to the consumer's account with the EMR bank 305.

Following the advocate being posted on the EMR Bank, the EMR bank system will first determine if it is a positive comment 401. If it is a positive advocate 402, the system will start to track its influence 404. The influence level of each response to the posted advocate will be measured 405. And the corresponding reward points of that influence level will be added into the consumer's account 406. If it is not a positive advocate 403, the system will not track its influence.

With an advocate being posted on the EMR Bank, its influence will be tracked and measured by the system. Meanwhile, the consumer may post another advocate for the same order or other orders he has enjoyed.

Concerning the various influence levels, there would be different responses to an advocate, which corresponds to different levels of influences. And this could be tracked and measured by the EMR bank system. For example, when a response to an advocate has been made 601, the EMR Bank system will track the response 602. If it is just checking the posted material, such as the advocate words or photos etc 603, it will produce a normal level influence 606. If the response also includes clicking the link in the post and entering the product website 604, it may be measured as a middle level influence 607. On the other hand, such actions as liking or recommending the post, marking the post or recommendation helpful or accepting the invitation to the product's Facebook page 605 may produce a high level influence 608. According to the level of the influence, the corresponding reward points will be added to the consumer (who made the advocate)'s account with the EMR Bank 609.

Then the EMR bank will keep tracking and measuring the influence of each response of an advocate, and recording the reward points to the consumer's account 401. The reward points will be accumulated in the consumer's account at the EMR bank until it reaches a predetermined level that can be redeemed.

The reward points in a consumer's account will be monitored closely 501. When the accumulated reward points reach certain pre-determined level, the EMR bank system will notify the consumer that the reward points in his account is good enough to make redemption for a reward 502. Additionally, in the case when multiple reward options are available, the customer will be allowed to choose the one he wants.

The possible methods for reward redemption may include offering a discount deeper than publically available discounts, e.g. $20 lower than the best available discount, upgrading product/service to another level, e.g. a $60 ticket may be upgraded to a ticket of $170, or offering the eligibility to services not publically available, e.g. the access to a VIP lounge.

Following the customer redeeming his reward points 503, the merchant will pay the same value of reward points to the EMR bank 504, as well as a transaction fee 505 to the EMR Bank.

Finally, the EMR Bank will exchange the redeemed reward points into a corresponding reward for the consumer 506. Various reward redemption models can be applied. In a dedicated reward redemption model, a user can spend earned points only on the products or services the same merchant offers, and merchants only pays for the influence of advocates for themselves. In contrast, in a shared reward redemption model, a user can redeem reward points at any merchant within a “pool”, and merchants put their products or services in the pool that opens to all users to redeem. So with the EMR Bank, personal influence is measureable and exchangeable with certain rewards. In this way, the EMR Bank can benefit both customers and merchants.

The EMR Bank would be a profitable business model by earning agent (transaction) fees for each transaction. The EMR Bank may be constructed as an advocate and reward management system, comprising an advocate influence tracking unit for tracking and measuring the influence of users' advocates, a reward redemption unit for redeeming reward points into certain types of rewards, discounts or benefits for users and an advocate center for storing and managing posted advocates.

As being mentioned above, in order to apply the EMR Bank into the real market, the EMR Bank could be linked to from a smartphone software application called On Location Master Menu (OLMM), from online stores or directory services. Also, a vendor providing products or services can be allowed to open accounts in the EMR Bank, and the vendor's existing customers can be directed to the EMR Bank from its website or physical stores. The OLMM is application software that can be installed on smartphones such as iPhone, so as to allow their users to check menus of a merchant's service or product on their phones from anywhere, choose the item and order it with all available coupons or reward points, and following the order, pay bill on the phone directly. Now more and more people would like to utilize a convenient electronic payment system to make the payment at their tables of a restaurant or elsewhere, and also like to use a smartphone application to do such transaction. Therefore, the EMR system has been made very easy to be linked to from such applications like OLMM, when people use their smartphone to make order or do other transactions.

With the OLMM, the merchants can attract more customers by offering do it yourself (DIY) style order and pay, convenient table reservation and one stop comments posting and reward point earning through a smartphone. Also, the merchants can collect more feedbacks since customers are more likely to make comments immediately after they have enjoyed the service. The customer feedbacks are critical to the merchants to improve their customer satisfactions and the quality of their services. With the synergy of the EMR bank system and the smartphone applications like OLMM, a merchant can offer a better service to its customers; provide visibility and convenience for them to reserve table, to make order and payment, as well as to save customers' time and money.

To serve those customers using the OLMM and the EMR Bank, restaurants could install a Restaurant Console platform that can be realized by using iPad and a Restaurant Management platform. Then, the process of advocate, reward and the like can be implemented by interactions among the three platforms: Restaurant Console platform, Restaurant Management platform, and System Management platform that is implemented in the EMR Bank system.

The Restaurant Console platform may comprise the modules of User log in, User profile, Merchant report, Order handle, Daily clearance, and Settlement. The module of User log in may be constructed to make a user see the login screen when the application launches and be able to type in the user name and password to log into the system. The module of User profile may be built to manage user profiles, and thus a user can be able to change his profile information such as first name, last name and contact information. Also, the user should be able to change his password.

The Merchant report module may be configured to provide various kinds of reports in accordance with a user's queries. For example, the Merchant report module may comprise an Order report unit configured to present an order report having the information of order total, loyalty discount, points discount, coupon discount, total discount and the like whenever a user queries the order report; a Dish report unit configured to present a dish report having the information of dish category, dish name, dish icon, order total amount, order total count, and the like whenever a user queries the dish report; a Customer report unit configured to present a customer report having the information of customer ID, order total, loyalty discount, points discount, coupon discount, total discount and the like whenever a user queries the customer report; and a Settlement report unit configured to present a settlement report having the information of order total, loyalty discount, points discount, coupon discount, paid total, settlement total and the like whenever a user queries the settlement report; and a User advocate unit configured to present advocates of the restaurant whenever a user queries.

The Order handle module may allow a user to make orders and see the information associated with the orders and may comprise an Unhandled order unit, by which the user should be able to see an unhandled order list and a newly committed order within 30 seconds, get notified of a newly unhandled order by sound, and see the order detail of each unhandled order; a Confirm unhandled order unit, by which the user should be able to confirm the unhandled order from the unhandled order list and see the confirmed order in the confirmed order list immediately, and the customer should be able to see the order confirmation through his smartphone application within 30 seconds; a Change confirmed order unit, by which the user should be able to see the confirmed order list, see the detail of the confirmed order, change the dishes in the order, and change the table number, wherein to change the dishes in the order may include to delete a dish, change dish configuration, change size, change number and add new dish; a unit of Input order into point of sale (POS) system, by which the user should at least be able to input the order to the restaurant's POS system and discount the order to $0 since it is already paid in the EMR Bank system; a Deliver order unit, by which the user should be able to change the order status to “delivered” when all the dishes are delivered, and see the order appear in the delivered order list, and the customer should be able to receive a “delivered” message in his smartphone application within 30 seconds and pay the order when it is delivered; an unit of Add dish after delivery, by which the user should be able to add dish to order after the delivery; a Payment notification unit, by which the user should be able to see payment notification after the customer paid the order, and the paid order should be moved from the “delivered” list to “paid” list; a User unpaid orders query unit, by which the user should be able to query the unpaid orders, see the following information in the report: customer name, table number, order time, order total, order status and so on, and see the order detail by clicking on an order.

The Daily clearance module may be configured to allow the user to see the order list of the working day, see the details of each order in the list, confirm the order list, mark the problematic orders and save them, and to make the EMR Bank agent be notified of those problematic orders. The Settlement module is mainly configured to handle unsettled orders, i.e., orders that EMR bank should settle with merchants. By the Settlement module, the user should be able to query the merchant unsettled orders, see a report having the information of order ID, customer name, order time, order total, loyalty discount, point discount, coupon discount, paid total and so on, and be able to see the order detail by clicking on an order.

The Restaurant Management platform may comprise at least the modules of User log in, User profile, Administration, Payment clearance, Settlement and Reports, wherein the User log in module and the User profile module are similar to those in the Restaurant Console platform.

The Administration module is the key module in the Restaurant Management platform and configured to allow a restaurant administrator to manage all kinds of restaurant related information. The Administration module may include a User management unit, by which the restaurant administrator should be able to add users of the restaurant, disable users of the restaurant, reset the password of a given user, change user register information, and assign or remove roles to users; a Store information management unit, by which the restaurant administrator should be able to manage store information, such as name, location, cuisine, etc.; a Store menu management unit, by which the restaurant administrator should be able to create, update, delete store menu, menu category, dish, dish configuration and the like, and manage prices of different sizes of each dish; an Order discount management unit, by which the restaurant administrator should be able to set the discount data of a single order and order add up; a User discount management unit, by which the restaurant administrator should be able to set specific discount to individual users; a Coupon management unit, by which the restaurant administrator should be able to create coupons of this restaurant and give coupons to customers, be able to identify user list by minimum add up expense, minimum single order expense, ordering in recent months and number of visits in a given period of time, and give coupons to those identified customers, also by which customers should own the same coupon once and be able to receive coupon notification, wherein the coupon can be discount percentage coupon or discount amount coupon, and should have a valid time range, a “use count”, a barrier which specifies the minimum order expense to be able to apply this coupon, and a description and an image to be sent to the customer; a Points mapping management unit, by which the restaurant administrator should be able to set the points/dollar mapping.

The Payment clearance module may be configured to allow daily clearance and also make the user be able to check the restaurant clearance data, query problematic orders of the restaurant, view order details and user details, and add notes to the problematic orders. The Settlement module may be configured to enable the restaurant administrator to check the unconfirmed settlement from the EMR Bank and confirm the settlement from the EMR Bank. The Reports module may be configured to enable the restaurant administrator to see all the reports from the Restaurant Console platform.

The System Management platform may be implemented in the EMR Bank, and comprise at least the modules of User log in, User profile, Administration, Customer management, Payment clearance, and Settlement management, wherein the User log in module and the User profile module are similar to those in the Restaurant Console platform and the Restaurant Management platform.

The Administration module may be configured to allow a system administrator to manage various system information, and may include a User management unit, by which the system administrator should be able to add or disable users, reset the password of a given user, change user register information, and assign or remove roles to users; a Store information management unit, by which the system administrator should be able to add new stores, manage store information such as name, location, cuisine, etc., and disable a store; an advocate reward setting management unit, by which the system administrator should be able to manage advocate reward settings such as reward points for different advocate activities and reward points for creating advocate according to the size of friend group; a settlement setting management unit, by which the system administrator should be able to manage settlement settings such as maximum discount, portion, and settlement period; a Geography information management unit, by which the system administrator should be able to add, change and delete countries, states, or cities; a Localization information management unit, by which the system administrator should be able to add or delete supported languages, and manage localization information; and a Global parameter setting management unit, by which the system administrator should be able to manage global parameter settings.

The Customer management module may be configured to allow a user to query customers by name, customer advocates, customer advocate activities, customer points, customer reward history and customer orders.

The Payment clearance module may be configured to allow a user to query orders which have not been marked with “paid confirmed”, mark those orders from the list which is in the “bank statement”, and confirm the payment, and also able to check the restaurant clearance data, query problematic orders of the restaurant, view order details and user details, and add notes to the problematic orders.

The Settlement management module may be configured to allow a user to query settlement of each restaurant, unsettled orders of each restaurant, problematic orders of each restaurant, and orders based in the settlement period, generate settlement sheet and send to financial department for the payment, and see the confirmed settlement.

As mentioned above, the OLMM can be the interface to link a user to the EMR Bank so that the user can conveniently take advantages of all the services provided by the EMR Bank. The integration of the OLMM and the EMR Bank would realize the ideal model of On Place to Choose, Save, Share and Earn. With this model, the user can easily complete all the operations including choosing and ordering, saving and paying, advocating, and earning rewards by using the OLMM application installed on his smartphone.

Hereinafter, three exemplary cases for business application will be described to further explain the operations of the EMR Bank system according to the present invention.

A case of Table Reservation may involve the following steps: through an application on his smartphone, a consumer indicates to reserve a table with a number of coming customers and expected arrival time; the system informs the consumer the available tables fit his needs; the consumer confirms the reservation; the system informs the restaurant the reservation request and set the reservation as “To be confirmed”; the restaurant receives the reservation request and confirms the request; the system sends the confirmation to the consumer and the table reservation case ends.

In a case of the On Location Ordering, a consumer “checks-in” the restaurant and the table where they sit; the system shows the consumer Today's Menu for the restaurant; the consumer reviews the multi-media menu with existing comments, including “advocates” that were given by the other customers for the restaurant or for the item; the system offers the consumer available promotions or coupons for the restaurant on the day; optionally, the consumer may also buy a coupon through the OLMM application; the consumer chooses the menu item and coupon and places the order; optionally a restaurant staff recommends certain items and from his iPad “pushes” them into the consumer's order that can be seen immediately by the consumer on his smartphone through the OLMM application; the system sends the order to the restaurant; the restaurant receives the order and confirms it; the system sends an “Order Accepted” message to the consumer; the system sends a “Ready To Serve” message to the consumer once the food is ready; the consumer enjoys the food service; optionally, the consumer posts “advocate” for the dishes and the restaurant after enjoying the food service; also optionally, the system starts to track and evaluate the “positive influence” of the consumer's “advocate” and adds up the “reward points” for the consumer for his advocate; the consumer finishes the dishes and pays for the order on his smartphone within the OLMM application; the system immediately evaluates the loyal customer points and adds it up to the consumer's account; optionally, the system offers a survey to the consumer with offering additional loyal customer reward points if it's answered; then the system notifies the restaurant the consumer checks-out and the On Location Ordering case ends.

Another case is a Drive Through Ordering case, which may comprise the following steps: a consumer “checks-in” the restaurant or food court for “pickup”; the consumer chooses menu items and coupon and places the order; the restaurant or food court sends the food items to the “Drive Through Point of Service” and stores it in a “locker” that can be opened only by scanning a correct barcode; the system sends “Ready To Pickup” message to the consumer once the food is ready; and the consumer drives through, shows the barcode on the phone through OLMM application to pick up his food items.

While the process described above includes a number of operations that appear to occur in a specific order, it should be apparent that these processes may include more or fewer operations, which may be executed serially or in parallel. Furthermore, the foregoing description provides an implementation disclosure of the invention, which is not limited by the detailed description but only by the scope of the appended claims. All those other aspects of the invention that will become apparent to a person of skill in the art, who has read the foregoing, are within the scope of the invention and of the following claims.

What is claimed is:

1. A non-transitory computer-readable medium that stores instructions executable by one or more processors to perform a menu level advocate and reward process, comprising
instructions for making and storing an advocate;
instructions for tracking and measuring an influence of said advocate; and
instructions for redeeming reward points for a corresponding reward.

2. The non-transitory computer-readable medium that stores instructions executable by one or more processors to perform the menu level advocate and reward process of claim 1, comprising
instructions for opening a merchant account with an EMR Bank by a merchant;
instructions for posting a menu of products or services of said merchant on the EMR Bank; and
instructions for opening a consumer account with the EMR Bank by a consumer.

3. The non-transitory computer-readable medium that stores instructions executable by one or more processors to perform the menu level advocate and reward process of claim 2, comprising
instructions for making an order from said menu of said merchant on the EMR Bank;
instructions for sending said order to said merchant for confirmation;
instructions for sending an order confirmation to said consumer; and
instructions for saving a confirmed order into said consumer's consumer account with the EMR Bank.

4. The non-transitory computer-readable medium that stores instructions executable by one or more processors to perform the menu level advocate and reward process of claim 3, comprising
instructions for prompting said consumer to an EMR Bank webpage when said order is completed;
instructions for determining to make said advocate “now” or “later”; and
instructions for going to the step of instructions for making and storing said advocate when the determination is “now”.

5. The non-transitory computer-readable medium that stores instructions executable by one or more processors to perform the menu level advocate and reward process of claim 1, the step of instructions for making and storing said advocate comprising
instructions for prompting a consumer to start making said advocate;
instructions for providing templates for making said advocate;
instructions for making said advocate by modifying said templates, or making said advocate without referring to said templates;
instructions for asking who is allowed to see said advocate; and
instructions for posting said advocate to said consumer's consumer account with the EMR Bank.

6. The non-transitory computer-readable medium that stores instructions executable by one or more processors to perform the menu level advocate and reward process of claim 1, the step of instructions for tracking and measuring said influence of said advocate comprising
instructions for determining to monitor said influence of said advocate;
instructions for tracking a response to said advocate when the determination is to monitor said influence of said advocate;
instructions for measuring an influence level of said response; and
instructions for recording corresponding reward points of said response to said consumer's said consumer account with the EMR Bank.

7. The non-transitory computer-readable medium that stores instructions executable by one or more processors to perform the menu level advocate and reward process of claim 1, the step of instructions for redeeming said reward points for said reward comprising
instructions for monitoring reward point accumulation in said consumer account;
instructions for notifying said consumer to redeem said reward points when said reward point accumulation reaches a pre-determined level;
instructions for redeeming said reward points for said corresponding reward;
instructions for making said merchant to pay same value reward points as the redeemed reward points;
instructions for making said merchant to pay a transaction fee; and
instructions for providing said corresponding reward.

8. The non-transitory computer-readable medium that stores instructions executable by one or more processors to perform the menu level advocate and reward process of claim 1, comprising
instructions for making an order from sources other than the EMR Bank;
instructions for the EMR Bank receiving information of said order from said sources other than the EMR Bank;
instructions for prompting a consumer who makes said order to an EMR Bank webpage when said order is completed;
instructions for determining if the consumer who makes said order already has a consumer account with the EMR Bank; and
instructions for opening said consumer account, when said consumer does not have said consumer account with the EMR Bank.

9. The non-transitory computer-readable medium that stores instructions executable by one or more processors to perform the menu level advocate and reward process of claim 8, the step of instructions for making said order from sources other than the EMR Bank comprising
instructions for making said order using a smartphone application;
instructions for making said order from a merchant's website;
instructions for making said order from a directory service; and
instructions for making said order from a physical location of a merchant.

10. The non-transitory computer-readable medium that stores instructions executable by one or more processors to perform the menu level advocate and reward process of claim 9, comprising
instructions for said smartphone application comprising On Location Master Menu (OLMM).

11. The non-transitory computer-readable medium that stores instructions executable by one or more processors to perform the menu level advocate and reward process of claim 6, comprising
instructions for assigning said influence level as high, as long as said response comprises one or more actions selected from the group consisting of liking the advocate, recommending the advocate, marking the advocate as helpful, marking the advocate's recommendation as helpful and accepting an invitation in said advocate to go to a Facebook page;
instructions for assigning said influence level as middle, when said response comprises clicking a link in said advocate to enter a webpage and said response does not comprise said high influence level actions; and
instructions for assigning said influence level as normal, when said response is only checking said advocate.

12. A non-transitory computer-readable medium that stores instructions executable by one or more processors to perform a menu level advocate and reward process, comprising
instructions for opening a merchant account with an EMR Bank by a merchant;
instructions for posting a menu of products or services of said merchant on the EMR Bank;
instructions for opening a consumer account with the EMR Bank by a consumer;
instructions for making and storing an advocate; and
instructions for tracking and measuring an influence of said advocate.

13. The non-transitory computer-readable medium that stores instructions executable by one or more processors to perform the menu level advocate and reward process of claim 12, the step of instructions for making and storing said advocate comprising
instructions for prompting said consumer to start making said advocate;
instructions for providing templates for making said advocate;
instructions for making said advocate by modifying said templates, or making said advocate without referring to said templates;
instructions for asking who is allowed to see said advocate; and
instructions for posting said advocate to said consumer's consumer account with the EMR Bank.

14. The non-transitory computer-readable medium that stores instructions executable by one or more processors to perform the menu level advocate and reward process of claim 12, the step of instructions for tracking and measuring said influence of said advocate comprising
instructions for determining to monitor said influence of said advocate;
instructions for tracking a response to said advocate when the determination is to monitor said influence of said advocate;
instructions for measuring an influence level of said response; and
instructions for recording corresponding reward points of said response to said consumer's said consumer account with the EMR Bank.

15. The non-transitory computer-readable medium that stores instructions executable by one or more processors to perform the menu level advocate and reward process of claim 12, comprising
instructions for making an order from said menu of said merchant on the EMR Bank;
instructions for sending said order to said merchant for confirmation;
instructions for sending an order confirmation to said consumer;
instructions for saving a confirmed order into said consumer's consumer account with the EMR Bank;
instructions for prompting said consumer to an EMR Bank webpage when said order is completed;
instructions for determining to make said advocate “now” or “later”; and
instructions for going to the step of instructions for making and storing said advocate when the determination is “now”.

16. The non-transitory computer-readable medium that stores instructions executable by one or more processors to perform the menu level advocate and reward process of claim 12, comprising
instructions for making an order using a smartphone application, or
instructions for making an order from said merchant's website, or
instructions for making an order from a directory service, or
instructions for making an order from a physical location of said merchant;
instructions for the EMR Bank receiving information of said order;
instructions for prompting a consumer who makes said order to an EMR Bank webpage when said order is completed;
instructions for determining if said consumer who makes said order already has said consumer account with the EMR Bank;
instructions for opening said consumer account, when said consumer who makes said order does not have said consumer account; and
instructions for said smartphone application comprising On Location Master Menu (OLMM).

17. The non-transitory computer-readable medium that stores instructions executable by one or more processors to perform the menu level advocate and reward process of claim 14, comprising
instructions for assigning said influence level as high, as long as said response comprises one or more actions selected from the group consisting of liking the advocate, recommending the advocate, marking the advocate as helpful, marking the advocate's recommendation as helpful and accepting an invitation in said advocate to go to a Facebook page;
instructions for assigning said influence level as middle, when said response comprises clicking a link in said advocate to enter a webpage and said response does not comprise said high influence level actions; and
instructions for assigning said influence level as normal, when said response is only checking said advocate.

18. The non-transitory computer-readable medium that stores instructions executable by one or more processors to perform the menu level advocate and reward process of claim 15, comprising
instructions for monitoring reward point accumulation in said consumer account;
instructions for notifying said consumer to redeem reward points when said reward point accumulation reaches a pre-determined level;
instructions for redeeming said reward points for a corresponding reward;
instructions for making said merchant to pay same value reward points as the redeemed reward points;
instructions for making said merchant to pay a transaction fee; and
instructions for providing said corresponding reward.

19. A non-transitory computer-readable medium that stores instructions executable by one or more processors to perform a menu level advocate and reward process, comprising
instructions for opening a merchant account with an EMR Bank by a merchant;
instructions for posting a menu of products or services of said merchant on the EMR Bank;
instructions for opening a consumer account with the EMR Bank by a consumer;
instructions for making an order from said menu of said merchant on the EMR Bank;
instructions for sending said order to said merchant for confirmation;
instructions for sending an order confirmation to said consumer;
instructions for saving a confirmed order into said consumer's consumer account with the EMR Bank;
instructions for prompting said consumer to an EMR Bank webpage when said order is completed;
instructions for determining to make an advocate “now” or “later”;
instructions for prompting said consumer to start making said advocate when the determination is “now”;
instructions for providing templates for making said advocate;
instructions for making said advocate by modifying said templates, or making said advocate without referring to said templates;
instructions for asking who is allowed to see said advocate;
instructions for posting said advocate to said consumer's consumer account with the EMR Bank;
instructions for determining to monitor an influence of said advocate;
instructions for tracking a response to said advocate when the determination is to monitor said influence of said advocate;
instructions for measuring an influence level of said response;
instructions for assigning said influence level as high, as long as said response comprises one or actions selected from the group consisting of liking the advocate, recommending the advocate, marking the advocate as helpful, marking the advocate's recommendation as helpful and accepting an invitation in said advocate to go to a Facebook page;
instructions for assigning said influence level as middle, when said response comprises clicking a link in said advocate to enter a webpage and said response does not comprise said high influence level actions;
instructions for assigning said influence level as normal, when said response is only checking said advocate;
instructions for recording corresponding reward points of said response to said consumer's said consumer account with the EMR Bank;
instructions for monitoring reward point accumulation in said consumer account;
instructions for notifying said consumer to redeem reward points when said reward point accumulation reaches a pre-determined level;
instructions for redeeming said reward points for a corresponding reward;
instructions for making said merchant to pay same value reward points as the redeemed reward points;
instructions for making said merchant to pay a transaction fee; and
instructions for providing said corresponding reward.

20. The non-transitory computer-readable medium that stores instructions executable by one or more processors to perform the menu level advocate and reward process of claim 19, comprising
instructions for making an order from a smartphone application, wherein said smartphone application comprises On Location Master Menu (OLMM), or
instructions for making an order from said merchant's website, or
instructions for making an order from a directory service, or
instructions for making an order from a physical location of said merchant;
instructions for the EMR Bank receiving information of said order that is made from a source other than the EMR Bank;
instructions for prompting a consumer who makes the order from the source other than the EMR Bank to an EMR Bank webpage;
instructions for determining if said consumer who makes the order from the source other than the EMR Bank already has said consumer account; and
instructions for opening said consumer account, when said consumer who makes the order from the source other than the EMR Bank does not have said consumer account with the EMR Bank.
